(19) United States
(12) Patent Application Publication
(10) Pub. No.: US 2023/0091651 A1
(43) Pub. Date: Mar. 23, 2023

(54) DIETARY SUPPLEMENT AND METHOD FOR SYNTHESIS OF SAME

(71) Applicant: StrongCell LLC, Plano, TX (US)

(72) Inventor: Jason R. Wynn, Plano, TX (US)

(21) Appl. No.: 17/933,843

(22) Filed: Sep. 20, 2022

Related U.S. Application Data
(60) Provisional application No. 63/246,266, filed on Sep. 20, 2021.
(60) Provisional application No. 63/374,096, filed on Aug. 31, 2022.

(51) Int. Cl. A23L 33/155; A23P 10/30; A23L 33/17; A23L 33/16

(52) U.S. Cl. CPC A23L 33/155; A23P 10/30; A23L 33/17; A23L 33/16; A23V 2002/00

(57) ABSTRACT

A dietary supplement and method for synthesis of the same are disclosed. In one embodiment of the method, an NADH component is provided that includes at least partially microencapsulated nicotinamide having nicotinamide blended with water. A supplement component, such as collagen, coenzyme Q10, vitamins, and minerals, is provided. A mixed component, which is a liquid, is formed by mixing the NADH component with the supplement component at ambient conditions. The mixed component is subjected to a fill production process.

### PRIORITY AND CROSS-REFERENCE STATEMENT

This application claims priority to (1) co-pending U.S. Application Ser. No. 63/246,266 entitled “Dietary Supplement and Method for Synthesis of Same” and filed on Sep. 20, 2021 in the name of Jason R. Wynn; and (2) co-pending U.S. Application Ser. No. 63/374,096 entitled “Dietary Supplement and Method for Synthesis of Same” and filed on Aug. 31, 2022 in the name of Jason R. Wynn; both of which are hereby incorporated by reference, in entirety, for all purposes.

### TECHNICAL FIELD OF THE INVENTION

This invention relates, in general, to dietary supplements and, in particular, to a dietary supplement having a composition containing NADH and method for synthesis of the same to provide increased dietary efficacy.

### BACKGROUND OF THE INVENTION

NADH, or reduced nicotinamide adenine dinucleotide, is naturally made in the body from niacin, a type of B vitamin. NADH plays a role in generating energy in the body and may be taken in supplement form. Proponents of supplements containing NADH advocate that NADH can boost energy levels and improve mental clarity, alertness, concentration, memory, athletic performance, and endurance. The health benefits of existing solid-pill-based supplements containing NADH have been limited, however, as the human digestive systems doesn't fully absorb the NADH, thereby reducing efficacy. Alternative intravenous-based delivery systems have proven expensive and, in many instances, require a nurse or other medical practitioner to deliver the supplement. Improvements in dietary supplements are therefore needed.

### SUMMARY OF THE INVENTION

It would be advantageous to provide dietary supplements that have greater absorption and efficacy. It would also be desirable to enable a chemical-based solution for a dietary supplement having a composition containing NADH and method for synthesis of the same that furnishes an approachable and affordable product. It would be further desirable to enable a chemical-based solution providing a dietary supplement in liquid form. To better address one or more of these concerns, a dietary supplement and method for synthesis of the same are disclosed. In one embodiment of the method, an NADH component is provided that includes at least partially microencapsulated nicotinamide having nicotinamide blended with water. A supplement component, such as collagen, coenzyme Q10, vitamins, and minerals, is provided. A mixed component, which is a liquid, is formed by mixing the NADH component with the supplement component at ambient conditions. The mixed component is subjected to a fill production process. These and other aspects of the invention will be apparent from and elucidated with reference to the embodiments described hereinafter.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a flow diagram depicting one embodiment of a method for synthesis of a dietary supplement, according to the teachings presented herein; and

FIG. 2 is another flow diagram depicting another embodiment of a method for synthesis of a dietary supplement, according to the teachings presented herein.

### DETAILED DESCRIPTION OF THE INVENTION

While the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention, and do not delimit the scope of the present invention.

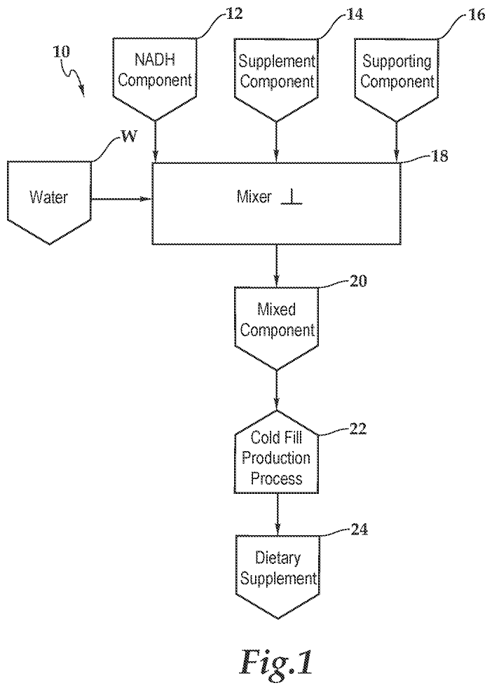

Referring initially to FIG. 1, therein is depicted one embodiment of a method for the synthesis of a dietary supplement and the like, which is generally designated 10. An NADH component 12, a supplement component 14, a supporting component 16, with or without water as a carrier, and water W are provided to a mixer 18, which provides agitation. In some embodiments, the water is reverse osmosis water. In one implementation, the mixing occurs at ambient conditions. Following the mixing, a mixed component 20 is provided that may undergo a cold fill production process 22 to yield a dietary supplement 24. During the cold fill process, a container or containers receive the mixed component 20 at ambient conditions or cold pressurized conditions to yield the dietary supplement 24. Then the cold product is added to the cold container. The cold fill production process also requires sterilization, which can be either a wet or dry sterilization. The various mixing and filling steps represented in FIG. 1 may be carried out in known commercial equipment currently used in the conventional dietary supplement production processes.

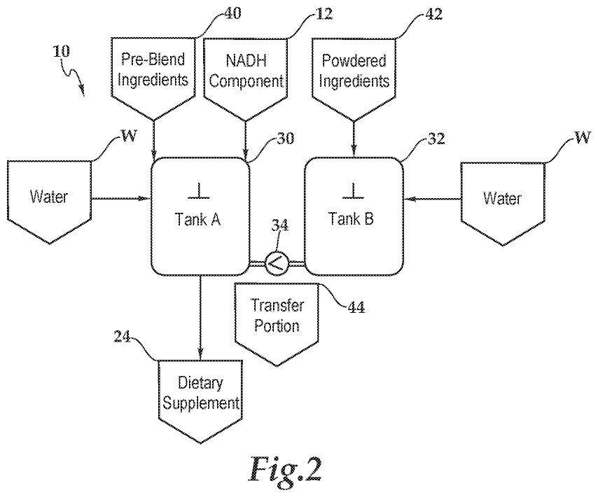

Referring now to FIG. 2, therein is depicted another embodiment of a method for the synthesis of a dietary supplement and the like, which is also generally designated 10. Two tanks 30, 32 with agitators are connected by a pump 34 that provides for the transfer of fluid from tank 32 to tank 30. At ambient temperature, add about 70% to about 90% of total (reverse osmosis) water, water W, at ambient temperature to tank 30, which may be a large stainless steel blending tank labeled as “Tank A.” The tank 30 may be large enough to hold total batch with approximately 30% overflow capacity for blending. The tank 30 may also have a cover to minimize light exposure during blending and bottle filling. Pre-blend ingredients 40, which may include portions of the supplement component 14 and the supporting component 16, such as a pre-blend thickener (e.g., xanthan gum) and a dispersing agent (e.g., allulose or the like), may be added to the tank 30.

Water W is slowly added under constant high shear agitation until homogenous conditions are meant. Such an operation may take at least ten minutes. A near balance of total water W is added to the tank 32, which may be a smaller stainless steel blending tank, labeled “Tank B.” The tank 32 must be large enough to hold about 50% of total batch, including overflow for blending. The tank 32 may have a cover to minimize light exposure during blending and bottle filling. Powered ingredients 42, including the remaining supplement component 14 and the supporting component 16, are added slowly, one at a time, and then subjected to blending under constant high shear agitation until well mixed. Such an operation should require blending for at least ten minutes. The tank 32 is kept covered as much as possible to prevent light exposure.

Transfer portion 44 of the contents of the tank 32 is then pumped or transferred from the tank 32 to the tank 30, with the tank 30 under constant agitation. In some embodiments, the pump 34 pumps the tank 32 from the bottom to ensure all contents are transferred uniformly to the tank 30. The tank 32 is covered as much as possible to prevent light exposure. Continued mixing in the tank 30 under appropriate shear prevents excess foaming until homogenous. This may take at least 20 minutes. Adjust with additional water (up to 2% total water) and/or citric acid as needed to match. Reduce blending speed and change blade and/or paddles to low shear blades/paddles. Blend at moderate speed with low shear while adding in the NADH component 12, including the encapsulated NADH. Ensure blending speed is sufficient to keep encapsulated NADH uniformly dispersed throughout the liquid. As with other steps, the tank 30 is covered as much as possible to prevent light exposure. Blending is sufficient maintained to achieve encapsulated NADH uniformity and prevent bottom sediment throughout the bottling process which provides the dietary supplement 24. By way of example, the dietary supplement 24 may be pumped as a liquid to a bottling line with capper with a deposit liquid of 2 fl oz into bottles and closure applied in-line. The filled bottles may be stored away from direct light exposure as much as possible during labeling and packing. The various mixing and filling steps represented in FIG. 2 may be carried out in known commercial equipment currently used in the conventional dietary supplement production processes. Further, it should be appreciated that although a particular architecture and design of manufacturing equipment is illustrated and described in FIG. 1 and FIG. 2, other architectures and designs of manufacturing equipment are within the teachings presented herein.

As depicted in FIG. 1 and FIG. 2, the method 10 includes mix-fill production equipment configured to receive the NADH component 12 and the supplement component 14 to produce the dietary supplement 24. The supporting component 16 relates to the gastrophysics of the dietary supplement 24 by forming the texture, taste, and aroma, for example. The dietary supplement 24 may have a pH of less than 5.0 in some embodiments and in other embodiments, the pH is less than 4.5 or 4.0. More particularly, in some embodiments, the pH is between about 2.5 and about 5.0; in other embodiments the pH is between about 2.5 and about 4.5; in still other embodiments, the pH is between about 2.5 and about 4.0; and in still further embodiments, the pH is between about 3.2 and about 3.6. The low, acidic pH acts as preservative and stabilizing mechanism enabling the dietary supplement 22 to avoid deterioration in the stomach and have high absorption in the intestines.

The dietary supplement 24 may have a Brix value of about 1 to about 85; more preferred from about 3 to about 30; even more preferred from about 5 to about 15; and most preferred from about 9 to about 15. The dietary supplement may have a viscosity, as measured in centipoise (cps) at 21.1° C., of about 0.05 to about 300,000; more preferred from about 0.05 to about 250,000; even more preferred from about 0.05 to about 100,000; and most preferred from about 1 to about 10,000.

In some embodiments, the NADH component 12 is about 0.000002% to about 6.0% by weight of the dietary supplement; in other embodiments, the NADH component 12 is about 0.002% to about 4.0% by weight of the dietary supplement; and in still other embodiments, the NADH component 12 is about 0.02% to about 1.0% by weight of the dietary supplement. More particularly, in one embodiment, the NADH component 12 includes at least partially microencapsulated nicotinamide having nicotinamide from about 0.000001% to about 3.0% by weight of the dietary supplement blended with water from about 15% to about 99% by weight of the dietary supplement. Microencapsulation, which provides the at least partially microencapsulated nicotinamide, is a process in which tiny particles of nicotinamide are surrounded by a coating created by a microencapsulation agent to give small capsules on a micro metric scale, while maintaining the useful properties. The microencapsulation agent may be present in at about a 1:1 ratio with the nicotinamide. That is, the microencapsulation agent may be from about 0.000001% to about 3.0% by weight of the dietary supplement. The microencapsulation agent may be, by way of example and not by way of limitation, lipids, carbohydrates, and/or proteins derived from vegetable oils, cellulose, alginates, and combinations thereof.

In another embodiment, the NADH component 12 includes at least partially microencapsulated nicotinamide from about 0.001% to about 2.0% by weight of the dietary supplement blended with water from about 25% to about 99% by weight of the dietary supplement. The microencapsulation agent may be present in at about a 1:1 ratio with the nicotinamide. That is, the encapsulation agent may be from about 0.001% to about 2.0% by weight of the dietary supplement. In a further embodiment, the NADH component includes at least partially microencapsulated nicotinamide from about 0.01% to about 0.5% by weight of the dietary supplement blended with water from about 50% to about 99% by weight of the dietary supplement. The microencapsulation agent may be present in at about a 1:1 ratio with the nicotinamide. That is, the encapsulation agent may be from about 0.01% to about 0.5% by weight of the dietary supplement. In each of these examples, the nicotinamide may include various sources such as, by way of example and not by way of limitation, NADH, NADPH, NADP+, NMN, and NR.

Nicotinamide-adenine-dinucleotide in its reduced form (“NADH”) and nicotinamide-adenine-phosphate-dinucleotide in its reduced form (“NADPH”) are physiological substances which occur in all living cells including human cells. These substances are cofactors for a variety of enzymes, the majority of which catalyze oxidation-reduction reactions. The most important function of NADH is its driving force for cell respiration. When using oxygen, NADH forms water and 3 ATP molecules in accordance with the following formula:

NADH+H+½O₂+3Pi+3ATP→NAD+3ATP+4H₂O.

Thus, with 1 NADH molecule, 3 ATP molecules are obtained which have an energy of approximately 21 kilocalories. This process is called oxidative phosphorylation. The supply of NADH and/or NADPH improves energy production. In the network of NADH and NADPH-related enzymes and precursors, NADP+ is a structural analogue of NAD+, which is synthesized by transferring a phosphate group from ATP to the 2′-hydroxyl group of the adenosine ribose moiety of NAD+. NMN is a product of niacin and sirtuins, which are a class of nicotinamide adenine dinucleotide-consuming enzymes, and NR is a NAD+ precursor.

In one embodiment, the supplement component 14 includes at least one of collagen, coenzyme Q10, vitamins, and minerals. The supplement component 14 may be from about 0.000001% to about 36% by weight of the dietary supplement. Alternatively, the supplement component may be from about 0.000001% to about 24% by weight of the dietary supplement. As a further alternative, the supplement may be from about 0.000001% to about 11% by weight of the dietary supplement.

The collagen may be collagen hydrolysate (as, for example, bovine) or collagen peptides (as, for example, marine and other sources). Further, the supplement component may include collagen in about 0.5% to about 10% by weight of the dietary supplement. In another embodiment, collagen may be provided in about 1.5% to about 7% by weight of the dietary supplement. In a further embodiment, the supplement component may include collagen in about 2% to about 5% by weight of the dietary supplement.

With respect to coenzyme Q10, in some embodiments, the supplement component may include coenzyme Q10 in about 0.000001% to about 3% by weight of the dietary supplement. In other embodiments, the supplement component may include coenzyme Q10 in about 0.001% to about 2% by weight of the dietary supplement. In still other embodiments, the supplement component may include coenzyme Q10 in about 0.01% to about 1.0% by weight of the dietary supplement.

With respect to vitamins, the vitamins may be at least one of Biotin, Vitamin K2 (as, for example, menaquinone-7), Vitamin B1, Vitamin B2, Vitamin B3, Vitamin B5, Vitamin B6, Vitamin B12, Vitamin D, Vitamin E, and Vitamin K1 (as, for example, phylloquinone). In some embodiments, the vitamins are provided in about 0.000001% to about 23% by weight of the dietary supplement. In some other embodiments, the vitamins are provided in about 0.000001% to about 15.0% by weight of the dietary supplement. In some still other embodiments, the vitamins are provided in about 0.000001% to about 5.0% by weight of the dietary supplement.

With respect to minerals, at least one of zinc and selenium may be selected. In some embodiments, the minerals may be provided in about 0.0001% to about 3.1% by weight of the dietary supplement in some embodiments. In some other embodiments, the minerals may be provided in about 0.0001% to about 2.01% by weight of the dietary supplement. In some other embodiments, the minerals may be provided in about 0.0001% to about 0.501% by weight of the dietary supplement. It should be appreciated that the selections of the composition of the supplement component 14, including the aforementioned collagen, coenzyme Q10, vitamins, and minerals, may vary from the exemplary presentations above and still be within the teachings presented herein.

With respect to supporting component 16, as discussed, the supporting component 16 relates to the gastrophysics of the dietary supplement 24 by forming the texture, taste, and aroma, for example. The supporting component 16 may include a wide-variety of compounds, such as, by way of example, natural sweeteners, flavorings, organic acids, preservatives (natural and synthetic), hydrocolloids, fiber, fruit peel or rind, and natural anti-inflammatory agents. In some embodiments, the supporting component 16 may be provided in about 0.000001% to about 51.0% by weight of the dietary supplement 24 in some embodiments. In some other embodiments, the supporting component 16 may be provided in about 0.001% to about 34.0% by weight of the dietary supplement 24. In some other embodiments, the supporting component 16 may be provided in about 0.01% to about 27.0% by weight of the dietary supplement 24. It should be appreciated that the selections of the composition of the supporting component 16 may vary from the exemplary presentations above and still be within the teachings presented herein.

The dietary supplement 24 may be a thick liquid which furnishes a liquid NADH dietary supplement. As NADH serves as the power source to every living cell in the human body and as NADH production generally declines with age, the dietary supplement presented herein provides the body with necessary fuel. Proponents of the dietary supplement presented herein advocate that the dietary supplement boosts energy levels and improves mental clarity, alertness, concentration, memory, athletic performance, and endurance, among other benefits.

The present invention will now be illustrated by reference to the following non-limiting working examples wherein procedures and materials are solely representative of those which can be employed and are not exhaustive of those available and operative. Tables I-III and Example I illustrates general and specific examples of utilizing NADH in a dietary supplement that includes additional vitamins and minerals to not only provide a liquid for human consumption and nutrition, but to increase efficiency and absorption of NADH and additional vitamins and minerals as well. The following glossary enumerates the components utilized in the Tables and Examples presented hereinbelow.

BIOTIN is 2′-keto-3,4-imidazolido-2-tetradydrothiophene-n-valeric acid and a member of the vitamin B complex; vitamin H.

CALCIUM PANTOTHENATE is the calcium salt of pantothenic acid or Ca(C₁₅H₃₁CO₂)₂

CHOLECALCIFEROL is activated 7-dehydrocholesterol or C₂₇H₄₄O, which is Vitamin D3.

CITRIC ACID is 2-hydroxyl-1,2,3-propanetricarboxylic acid.

COENZYME Q10 is CH₃C₆(O)₂(OCH₃)₂[CH₂CH:C(CH₃)CH₂]₁₀H.

COLLAGEN HYDROLYSATE (as, for example, marine or bovine) is a fibrous protein constituting most of the white fiber in connective tissues of animals.

COLLAGEN PEPTIDES (as, for example, marine or bovine) are small pieces of protein constituting most of the white fiber in connective tissues of animals.

CUCRUMIN is polyphenol with anti-inflammatory properties derived as a yellow pigment found primarily in turmeric, which is product of Curcuma longa, a flowering plant of the ginger family.

CYANOCOBALAMIN is C₆₃H₈₈CoN₁₄P or vitamin B12.

DI-ALPHA TOCOPHERYL ACETATE is C₃₁H₅₂O₃, which is a synthetic form of vitamin E.

Fiber is a fundamental form of solid characterized by relatively high tenacity and an extremely high ratio of length to diameter.

MENAQUINONE-7 is C₄₆H₆₄O₂; vitamin K2.

NADH is C₂₂H₂₇O₁₄N₇P₂ or nicotinamide adenine dinucleotide; which in its reduced form is NADPH or nicotinamide adenine phosphate dinucleotide.

NIACIN is pyridine-carboxylic acid, which is an antipellagra vitamin.

NIACINAMIDE is C₅N₄NCONH₂, which is a conversion of niacin to the amide.

ORANGE PEEL is product of fresh oranges made by removing the rind from the fresh oranges.

PANTOTHENIC ACID is N-(2-4-dihydroxy-3,3-dimethylbutyryl)-β-alanine, which is a member of the vitamin-B complex.

PHYLLOQUINONE also known as phytomenadione is C₃₁H₄₆O₂, which is vitamin K1.

POTASSIUM SORBATE is potassium-2,4-hexadienoate.

PYRIDOXINE is 3-hydroxy-4,5-dimethylol-2-methylpyridine, which is vitamin B6.

PYRIDOXINE HYDROCHLORIDE is the hydrochloride salt form of pyridoxine.

RIBOFLAVIN is 7,8-dimethyl-10-(1′-d-ribityl) isoalloxazine or vitamin B2.

SELENIUM is a nonmetallic element, atomic number 34.

SODIUM RIBOFLAVIN 5-PHOSPHATE is the sodium salt form of riboflavin.

SODIUM SELENITE is Na₂SeO₃.5H₂0.

STEVIOL GLYCOSIDES are chemical compounds derived from the leaves of the South American plant Stevia rebaudiana (as, for example, Asteraceae).

SUCRALOSE is C₁₂H₁₉C₁₃O₈, which is an artificial sweetener and sugar substitute.

TAPIOCA is a starch extracted from the storage roots of the cassava plant, which is Manihot esculenta.

THIAMIN is C₁₂H₁₇CIN₄OS, which is vitamin B1.

THIAMIN MONONITRATE is a synthetic nitrate salt form of thiamin.

VEGETABLE OIL is an oil extracted from the seeds, fruit, or nuts of plants and generally considered to be a mixture of glycerides.

VITAMIN B6 is pyridoxine.

VITAMIN B12 is cyanocobalamin.

VITAMIN D is cholecalciferol.

VITAMIN E is di-alpha tocopheryl acetate.

VITAMIN K1 is phylloquinone.

WATER is H₂O.

XANTHAN GUM is a carbohydrate high polymer derived from a synthetic, water-soluble biopolymer made by fermentation of carbohydrates.

ZINC is a metallic element with atomic number 30.

ZINC GLUCONATE is the zinc salt of gluconic acid.

A dietary supplement may be prepared having a composition as defined in the ranges provided in Table I.

TABLE I
Composition of Dietary Supplement

| Some Embodiments of | Percent of Total |
|---|---|
| Preferred Ranges*. | by Weight |
| Vitamin D (as, for | 0.00001%-0.1% |
| example, cholecalciferol) | |
| Vitamin E (as, for | 0.000001%-3% |
| example, di-alpha | |
| tocopheryl acetate) | |
| Vitamin K1 (as, for | 0.0001%-0.1% |
| example, phylloquinone) | |
| Thiamin (as, for | 0.001%-3% |
| example, thiamin | |
| mononitrate) | |
| Riboflavin (as, for | 0.001%-3% |
| example, sodium | |
| riboflavin 5-phosphate) | |
| Niacin (as, for example, | 0.000001%-3% |
| niacinamide) | |
| Vitamin B6 (as, for | 0.0001%-2% |
| example, pyridoxine | |
| hydrochloride) | |
| Vitamin B12 (as, for | 0.001%-3% |
| example, cyanocobalamin) | |
| Biotin | 0.000001%-0.1% |
| Pantothenic acid (as, | 0.001%-3% |
| for example, calcium | |
| pantothenate) | |
| Zinc (as, for example, | 0.001%-3% |
| zinc gluconate) | |
| Selenium (as sodium | 0.0001%-0.1% |
| selenite) | |
| Vitamin K2 (as, for | 0.0001%-2% |
| example, menaquinone-7) | |
| Collagen hydrolysate and | 0.5%-10% |
| collagen peptides (as, | |
| for example, marine) | |
| Microencapsulation agent | 0.000001%-3% |
| (as, for example, | |
| vegetable oil) | |
| Coenzyme Q10 | 0.000001%-3% |
| Nicotinamide | 0.000001%-3% |
| Orange peel | 0.000001%-5% |
| Natural sweeteners | 0.0001%-10% |
| Flavorings | 0.0001%-10% |
| Xanthan gum | 0.000001%-5% |
| Potassium sorbate | 0.000001%-3% |
| Fiber (as, for example, | 0.000001%-5% |
| tapioca) | |
| Cucrumin | 0.000001%-5% |
| Steviol glycosides | 0.000001%-5% |
| Water (as, for example, | Adjusted to above % |
| reverse osmosis) | or 15%-99% |

*Please note that all ranges in Table I are expressed as “about.” By way of example, with respect to Biotin, the range is about 0.000001% to about 0.1%. By way of a second example, with respect to coenzyme Q10, the range is about 0.000001% to about 3%. Additionally, please note that modifiers such as “(as, for example, cholecalciferol)” with respect to Vitamin D are exemplary and non-limiting examples for the formulation and other sources are within the teachings presented herein.

A dietary supplement may be prepared having a composition as defined in the ranges provided in Table II.

TABLE II
Composition of Dietary Supplement

| Some Embodiments of | Percent of Total |
|---|---|
| Preferred Ranges*. | by Weight |
| Vitamin D (as, for | 0.00001%-0.01% |
| example, cholecalciferol) | |
| Vitamin E (as, for | 0.001%-2% |
| example, di-alpha | |
| tocopheryl acetate) | |
| Vitamin K1 (as, for | 0.0001%-0.01% |
| example, phylloquinone) | |
| Thiamin (as, for | 0.001%-3% |
| example, thiamin | |
| mononitrate) | |
| Riboflavin (as, for | 0.001%-2% |
| example, sodium | |
| riboflavin 5-phosphate) | |
| Niacin (as, for example, | 0.001%-2% |
| niacinamide) | |
| Vitamin B6 (as, for | 0.0001%-1% |
| example, pyridoxine | |
| hydrochloride) | |
| Vitamin B12 (as, for | 0.001%-2% |
| example, cyanocobalamin) | |
| Biotin | 0.000001%-0.01% |
| Pantothenic acid (as, | 0.001%-2% |
| for example, calcium | |
| pantothenate) | |
| Zinc (as, for example, | 0.001%-2% |
| zinc gluconate) | |
| Selenium (as sodium | 0.0001%-0.01% |
| selenite) | |
| Vitamin K2 (as, for | 0.0001%-1% |
| example, menaquinone-7) | |
| Collagen hydrolysate and | 1.5%-7% |
| collagen peptides (as, | |
| for example, marine) | |
| Microencapsulation agent | 0.001%-2% |
| (as, for example, | |
| vegetable oil) | |
| Coenzyme Q10 | 0.001%-2% |
| Nicotinamide | 0.001%-2% |
| Orange peel | 0.001%-2% |
| Natural sweeteners | 0.5%-10% |
| Flavorings | 0.5%-10% |
| Xanthan gum | 0.001%-2% |
| Potassium sorbate | 0.001%-2% |
| Fiber (as, for example, | 0.001%-2% |
| tapioca) | |
| Cucrumin | 0.001%-2% |
| Steviol glycosides | 0.001%-2% |
| Water (as, for example, | Adjusted to above % |
| reverse osmosis) | or 25%-99% |

*Please note that all ranges in Table II are expressed as “about.” By way of example, with respect to Biotin, the range is about 0.000001% to about 0.01%. By way of a second example, with respect to coenzyme Q10, the range is about 0.001% to about 2%. Additionally, please note that modifiers such as “(as, for example, cholecalciferol)” with respect to Vitamin D are exemplary and non-limiting examples for the formulation and other sources are within the teachings presented herein.

A dietary supplement may be prepared having a composition as defined in the ranges provided in Table III.

TABLE III
Composition of Dietary Supplement

| Some Embodiments of | Percent of Total |
|---|---|
| Preferred Ranges*. | by Weight |
| Vitamin D (as, for | 0.00001%-0.001% |
| example, cholecalciferol) | |
| Vitamin E (as, for | 0.01%-0.1% |
| example, di-alpha | |
| tocopheryl acetate) | |
| Vitamin K1 (as, for | 0.0001%-0.001% |
| example, phylloquinone) | |
| Thiamin (as, for | 0.001%-0.5% |
| example, thiamin | |
| mononitrate) | |
| Riboflavin (as, for | 0.001%-0.5% |
| example, sodium | |
| riboflavin 5-phosphate) | |
| Niacin (as, for example, | 0.001%-1% |
| niacinamide) | |
| Vitamin B6 (as, for | 0.0001%-0.1% |
| example, pyridoxine | |
| hydrochloride) | |
| Vitamin B12 (as, for | 0.001%-0.5% |
| example, cyanocobalamin) | |
| Biotin | 0.000001%-0.001% |
| Pantothenic acid (as, | 0.001%-0.5% |
| for example, calcium | |
| pantothenate) | |
| Zinc (as, for example, | 0.001%-0.5% |
| zinc gluconate) | |
| Selenium (as sodium | 0.0001%-0.001% |
| selenite) | |
| Vitamin K2 (as, for | 0.0001%-0.1% |
| example, menaquinone-7) | |
| Collagen hydrolysate and | 2%-5% |
| collagen peptides (as, | |
| for example, marine) | |
| Microencapsulation agent | 0.01%-0.1% |
| (as, for example, | |
| vegetable oil) | |
| Coenzyme Q10 | 0.01%-1% |
| Nicotinamide | 0.01%-0.5% |
| Orange peel | 0.01%-1% |
| Natural sweeteners | 0.1%-10% |
| Flavorings | 0.1%-10% |
| Xanthan gum | 0.01%-1% |
| Potassium sorbate | 0.01%-5% |
| Fiber (as, for example, | 0.01%-1% |
| tapioca) | |
| Cucrumin | 0.01%-1% |
| Steviol glycosides | 0.01%-1% |
| Water (as, for example, | Adjusted to above % |
| reverse osmosis) | or 50%-99% |

*Please note that all ranges in Table III are expressed as “about.” By way of example, with respect to Biotin, the range is about 0.000001% to about 0.001%. By way of a second example, with respect to coenzyme Q10, the range is about 0.01% to about 1%. Additionally, please note that modifiers such as “(as, for example, cholecalciferol)” with respect to Vitamin D are exemplary and non-limiting examples for the formulation and other sources are within the teachings presented herein.

Example I. A dietary supplement with a serving size of one bottle being 0.85 fluid ounces (≈25 mL) was prepared according to the formulations provided in Tables I, II, and III as Preparation 1, as shown in Table IV:

TABLE IV
Composition of Dietary Supplement

| | Amount per Serving |
|---|---|
| Compound | in weight (g) |
| Vitamin D (as, for | 0.000015 |
| example, cholecalciferol) | |
| Vitamin E (as, for | 0.033 |
| example, di-alpha | |
| tocopheryl acetate) | |
| Vitamin K1 (as, for | 0.00025 |
| example, phylloquinone) | |
| Thiamin (as, for | 0.0055 |
| example, thiamin | |
| mononitrate) | |
| Riboflavin (as, for | 0.007 |
| example, sodium | |
| riboflavin 5-phosphate) | |
| Niacin (as, for example, | 0.008 |
| niacinamide) | |
| Vitamin B6 (as, for | 0.0007 |
| example, pyridoxine | |
| hydrochloride) | |
| Vitamin B12 (as, for | 0.001 |
| example, cyanocobalamin) | |
| Biotin | 0.000005 |
| Pantothenic acid (as, | 0.003 |
| for example, calcium | |
| pantothenate) | |
| Zinc (as, for example, | 0.0025 |
| zinc gluconate) | |
| Selenium (as sodium | 0.00055 |
| selenite) | |
| Vitamin K2 (as, for | 0.00075 |
| example, menaquinone-7) | |
| Collagen hydrolysate and | 2 |
| collagen peptides (as, | |
| for example, marine) | |
| Microencapsulation agent | 0.04 |
| (as, for example, | |
| vegetable oil) | |
| Coenzyme Q10 | 0.225 |
| Nicotinamide | 0.04 |
| Orange peel | 0.075 |
| Natural sweeteners | 1.63 |
| Flavorings | 1 |
| Xanthan gum | 0.16 |
| Potassium sorbate | 0.18 |
| Fiber (as, for example, | 0.09 |
| tapioca) | |
| Cucrumin | 0.022 |
| Steviol glycosides | 0.03 |
| Water (as, for example, | 54 |
| reverse osmosis) | |

The NADH and water components of Preparation 1 were mixed together and sufficiently blended to form a fluid at ambient conditions. The resulting NADH component was mixed with the remaining ingredients as a supplement component at ambient conditions and subjected to a fill production process of the type described in FIG. 1 or FIG. 2.

Example II. A dietary supplement with a serving size of one bottle being 0.85 fluid ounces (≈25 mL) was prepared according to the formulations provided in Tables I, II, and III as Preparation 2, as shown in Table V:

TABLE V
Composition of Dietary Supplement

| | Amount per Serving | |
|---|---|---|
| Compound | in weight | |
| NADH (as reduced B- | 40 | mg |
| nicotinamide adenine | | |
| dinucleotide) | | |
| Vitamin K1 (as | 100 | mcg |
| phylloquinone) and | | |
| Vitamin K2 (as | | |
| menaquinone-7) | | |
| Wild-caught Marine | 2.3 | g |
| Collagen Peptides | | |
| (Whitefish); Coenzyme | | |
| Q10; Organic Orange | | |
| (Citrus Sinensis, Dried | | |
| Peel, Cucumin Powder) | | |
| Vitamin D3 (as | 15 | mcg |
| cholecalciferol) | | |
| Vitamin E (as mixed | 60 | mg |
| tocopherols and di-alpha | | |
| tocopheryl acetate) | | |
| Vitamin Bl (as thiamin | 1.1 | mg |
| mononitrate) | | |
| Vitamin B2 (as | 1.4 | mg |
| riboflavin 5-phosphate) | | |
| Vitamin B3 (as | 16 | mg |
| niacinamide) | | |
| Vitamin B6 (as | 1.4 | mg |
| pyridoxine | | |
| hydrochloride) | | |
| Vitamin B12 (as | 1,000 | mcg |
| Methylcobalamin) | | |
| Vitamin B7 (as Biotin) | 5 | mcg |
| Pantothenic acid (as | 6 | mg |
| calcium pantothenate) | | |
| Zinc (as zinc gluconate) | 2.5 | mg |
| Selenium (as sodium | 55 | mcg |

selenite)

Other ingredients include reverse osmosis water, natural flavor, citric acid, tapioca fiber, and xanthan gum. Contains 0.5 percent or less of: Reb M (steviol glycosides from fermented sugarcane), and potassium sorbate (for freshness).

The NADH and water components of Preparation 2 were mixed together and sufficiently blended to form a fluid at ambient conditions. The resulting NADH component was mixed with the remaining ingredients as a supplement component at ambient conditions and subjected to a fill production process of the type described in FIG. 1 or FIG. 2.

With respect to Example II and corresponding Preparation 2, in use, the dietary supplement was found to have the nutritional value expressed in Table VI.

TABLE V
Composition of Dietary Supplement

| Compound | % Daily Value |
|---|---|
| NADH (as reduced B- | Not Established |
| nicotinamide adenine | |
| dinucleotide) | |
| Vitamin K1 (as | 115% |
| phylloquinone) and | |
| Vitamin K2 (as | |
| menaquinone-7) | |
| Wild-caught Marine | Not Established |
| Collagen Peptides | |
| (Whitefish); Coenzyme | |
| Q10; Organic Orange | |
| (Citrus Sinensis, Dried | |
| Peel, Cucumin Powder) | |
| Vitamin D3 (as | 75% |
| cholecalciferol) | |
| Vitamin E (as mixed | 400% |
| tocopherols and di-alpha | |
| tocopheryl acetate) | |
| Vitamin Bl (as thiamin | 92% |
| mononitrate) | |
| Vitamin B2 (as | 108% |
| riboflavin 5-phosphate) | |
| Vitamin B3 (as | 100% |
| niacinamide) | |
| Vitamin B6 (as | 82% |
| pyridoxine | |
| hydrochloride) | |
| Vitamin B12 (as | 41,666% |
| Methylcobalamin) | |
| Vitamin B7 (as Biotin) | 17% |
| Pantothenic acid (as | 120% |
| calcium pantothenate) | |
| Zinc (as zinc gluconate) | 23% |
| Selenium (as sodium | 100% |
| selenite) | |

Other ingredients include reverse osmosis water, natural flavor, citric acid, tapioca fiber, and xanthan gum. Contains 0.5 percent or less of: Reb M (steviol glycosides from fermented sugarcane), and potassium sorbate (for freshness).

The dietary supplement was a thick liquid, with a bright orange color and opaque appearance, consumed by pouring the one serving into ½ cup (4 fluid ounces or ≈118 mL) of water. The absorption rate of NADH was estimated over 98%. Users of the dietary supplement presented herein reported that the dietary supplement boosts energy levels and improves mental clarity, alertness, concentration, memory, athletic performance, and endurance, among other benefits.

The order of execution or performance of the methods and processes illustrated and described herein is not essential, unless otherwise specified. That is, elements of the methods and processes may be performed in any order, unless otherwise specified, and that the methods may include more or less elements than those disclosed herein. For example, it is contemplated that executing or performing a particular element before, contemporaneously with, or after another element are all possible sequences of execution.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A method for synthesis of a dietary supplement, the method comprising:
providing an NADH component including at least partially microencapsulated nicotinamide having nicotinamide from about 0.000001% to about 3.0% by weight of the dietary supplement blended with water from about 15% to about 99% by weight of the dietary supplement;
providing a supplement component from about 0.000001% to about 36% by weight of the dietary supplement;
forming a mixed component by mixing the NADH component with the supplement component at ambient conditions, the mixed component being a liquid at the ambient conditions having a pH between about 2.5 and about 5.0; and
subjecting the mixed component to a fill production process.

2. The method as recited in claim 1, wherein providing the NADH component, further comprises furnishing the at least partially microencapsulated nicotinamide having nicotinamide from about 0.001% to about 2.0% by weight of the dietary supplement.

3. The method as recited in claim 1, wherein providing the NADH component, further comprises furnishing the at least partially microencapsulated nicotinamide having nicotinamide from about 0.01% to about 0.5% by weight of the dietary supplement.

4. The method as recited in claim 1, wherein providing the NADH component, further comprises providing a microencapsulation agent from about 0.000001% to about 3.0% by weight of the dietary supplement, the microencapsulation agent being selected from the group consisting of derivatives of vegetable oils, celluloses, alginates, and combinations thereof.

5. The method as recited in claim 1, wherein providing the NADH component, further comprises providing a microencapsulation agent from about 0.01% to about 2.0% by weight of the dietary supplement, the microencapsulation agent being selected from the group consisting of derivatives of vegetable oils, celluloses, alginates, and combinations thereof.

6. The method as recited in claim 1, wherein providing the NADH component, further comprises providing a microencapsulation agent from about 0.01% to about 0.5% by weight of the dietary supplement, the microencapsulation agent being selected from the group consisting of derivatives of vegetable oils, celluloses, alginates, and combinations thereof.

7. The method as recited in claim 1, wherein the pH is between about 2.5 and about 4.5.

8. The method as recited in claim 1, wherein the pH is between about 2.5 and about 4.0.

9. The method as recited in claim 1, wherein the mixed component comprises a Brix value of about 1 to about 85.

10. The method as recited in claim 1, wherein the mixed component comprises a Brix value of about 3 to about 30.

11. The method as recited in claim 1, wherein the mixed component comprises a Brix value from about 5 to about 15.

12. The method as recited in claim 1, wherein the mixed component comprises a viscosity, as measured in centipoise (cps) at 21.1° C., of about 0.05 to about 300,000.

13. The method as recited in claim 1, wherein the mixed component comprises a viscosity, as measured in centipoise (cps) at 21.1° C., of about 0.05 to about 250,000.

14. The method as recited in claim 1, wherein the mixed component comprises a viscosity, as measured in centipoise (cps) at 21.1° C., of about 0.05 to about 100,000.

15. The method as recited in claim 1, wherein providing the supplement component, further comprises providing collagen in about 0.5% to about 10% by weight of the dietary supplement.

16. The method as recited in claim 1, wherein providing the supplement component, further comprises providing collagen in about 1.5% to about 7% by weight of the dietary supplement.

17. The method as recited in claim 1, wherein providing the supplement component, further comprises providing collagen in about 2% to about 5% by weight of the dietary supplement.

18. The method as recited in claim 1, wherein providing the supplement component, further comprises providing Coenzyme Q10 in about 0.000001% to about 3% by weight of the dietary supplement.

19. The method as recited in claim 1, wherein providing the supplement component, further comprises providing Coenzyme Q10 in about 0.001% to about 2% by weight of the dietary supplement.

20. The method as recited in claim 1, wherein providing the supplement component, further comprises providing Coenzyme Q10 in about 0.01% to about 1.0% by weight of the dietary supplement.

21. The method as recited in claim 1, wherein providing the supplement component, further comprises providing vitamins.

22. The method as recited in claim 21, wherein the vitamins are selected from the group consisting of Biotin, Vitamin K2, Vitamin B1, Vitamin B2, Vitamin B3, Vitamin B5, Vitamin B6, Vitamin B12, Vitamin D, Vitamin E, and Vitamin K1.

23. The method as recited in claim 1, wherein providing the supplement component, further comprises providing minerals.

24. The method as recited in claim 17, wherein the minerals are selected from the group consisting of zinc and selenium.

25. A method for synthesis of a dietary supplement, the method comprising:
providing an NADH component including at least partially microencapsulated nicotinamide having nicotinamide from about 0.001% to about 2.0% by weight of the dietary supplement blended with water from about 25% to about 99% by weight of the dietary supplement, the NADH component including a microencapsulation agent from about 0.01% to about 2.0% by weight of the dietary supplement, the microencapsulation agent being selected from the group consisting of derivatives of vegetable oils, celluloses, alginates, and combinations thereof;
providing a supplement component from about 0.000001% to about 24% by weight of the dietary supplement, the supplement component including at least one of collagen, coenzyme Q10, vitamins, and minerals;
forming a mixed component by mixing the NADH component with the supplement component at ambient conditions, the mixed component being a liquid at the ambient conditions having a pH between about 2.5 and about 4.5, the mixed component having a Brix value of about 3 to about 30, the mixed component having a viscosity, as measured in centipoise (cps) at 21.1° C., of about 0.05 to about 250,000; and
subjecting the mixed component to a fill production process.

26. A method for synthesis of a dietary supplement, the method comprising:
providing an NADH component including at least partially microencapsulated nicotinamide having nicotinamide from about 0.01% to about 0.5% by weight of the dietary supplement blended with water from about 50% to about 99% by weight of the dietary supplement, the NADH component including a microencapsulation agent from about 0.01% to about 0.5% by weight of the dietary supplement, the microencapsulation agent being selected from the group consisting of derivatives of vegetable oils, celluloses, alginates, and combinations thereof;
providing a supplement component from about 0.000001% to about 11% by weight of the dietary supplement, the supplement component including collagen, coenzyme Q10, vitamins, and minerals;
forming a mixed component by mixing the NADH component with the supplement component at ambient conditions, the mixed component being a liquid at the ambient conditions having a pH between about 2.5 and about 4.0, the mixed component having a Brix value of about 5 to about 15, the mixed component having a viscosity, as measured in centipoise (cps) at 21.1° C., of about 0.05 to about 100,000; and
subjecting the mixed component to a fill production process.
